(19) United States
(12) Patent Application Publication
(10) Pub. No.: US 2026/0196928 A1
(43) Pub. Date: Jul. 9, 2026

(54) TOTEM POLE POWER FACTOR CORRECTION SYSTEM

(71) Applicant: SIGNIFY HOLDING B.V., EINDHOVEN (NL)

(72) Inventors: REINHOLD ELFERICH, AACHEN (DE); CHRISTIAN HATTRUP, WURSELEN (DE)

(21) Appl. No.: 19/129,001

(22) PCT Filed: Nov. 14, 2023
(86) PCT No.: PCT/EP2023/081686

§ 371 Date: May 10, 2025

(30) Foreign Application Priority Data
Nov. 17, 2022 (EP) 2207936.0

(51) Int. Cl. H02M 1/42; H02M 1/44

(52) U.S. Cl. CPC H02M 1/4225; H02M 1/44

(57) ABSTRACT

A mechanism for facilitating quasi-square wave control of a totem pole power factor correction system that makes use of rectifying diodes in the rectifying system and comprises a synchronous boost PFC converter. The mechanism comprises a boost input decoupler, formed of a pair of clamping diodes and decoupling capacitors, that decouples the input of the synchronous boost PFC converter from an input interface (which receives an AC input signal for conversion).

### FIELD OF THE INVENTION

The present invention relates to the field of power factor correction systems.

### BACKGROUND OF THE INVENTION

There is an increasing use of power factor correction (PFC) systems in a wide variety of electrical goods in order to improve the efficiency of such electrical devices. Indeed, power factor correction systems are often seen as being indispensable or essential for many electrical devices in order to achieve required power factors for the electrical device(s). One example of a power factor correction system is a totem pole power factor correction system, which is sometimes called an asymmetrical bridgeless boost rectifier.

There has been a growing interest in different control schemes for power factor correction systems, with new modes of operation being introduced in recent times. These modes include: the continuous conduction mode (CCM), the discontinuous conduction mode (DCM), the boundary/transition conduction mode (BCM) and the quasi-square wave (QSW) mode.

There is an ongoing desire to improve the performance and reliability of PFC systems, and particularly totem pole PFC systems.

### SUMMARY OF THE INVENTION

The invention is defined by the claims.

According to examples in accordance with an aspect of the invention, there is provided a totem pole power factor correction system for driving a load.

The totem pole power factor correction circuitry comprises: an input interface comprising a first input node and a second input node for receiving an AC input signal from an external power supply and an impedance connecting the first input node to the second input node; an output interface for providing a driving signal to a load, the output interface comprising: a first output node and a second output node for connecting to the load; and an output capacitor connected between the first output node and the second output node; a synchronous boost PFC converter comprising: an inductor coupled between the first input node and an intermediate node; a first switch connected between the intermediate node and the first output node; and a second switch connected between the intermediate node and the second output node; a rectifying system comprising: a first rectifying diode connected between the second input node and the first output node; and a second rectifying diode connected between the second output node and the second input node; and a boost input decoupler.

The boost input decoupler comprises a first clamping diode connected between the first input node and the first output node; a second clamping diode connected between the second output node and the first input node; and one or more decoupling capacitors, wherein each decoupling capacitor is connected between either: the first input node and the first output node; or the first input node and the second output node.

The present disclosure proposes a mechanism for both facilitating a QSW control technique and the use of rectifier diodes for the rectifying system (of a totem pole-based system) by decoupling the input to the synchronous boost PFC converter (i.e., the first input node) from the rectifier and the input interface.

This modification means that the voltage at the input to the synchronous boost PFC converter is decoupled from the AC input signal itself.

The one or more decoupling capacitors may comprise a first decoupling capacitor connected between the first input node and the first output node; and a second decoupling capacitor connected between the first input node and the second output node.

The input interface comprises an EMI filter for performing EMI filtering on the AC input signal received by the input interface. Use of an EMI filter will reduce electromagnetic interference in the AC input signal.

Proposed concepts are particularly advantageous when the PFC system comprises such an EMI filter.

Operating the power factor correction system will typically result in the occurrence of a large voltage step at the first input node for each zero-crossing of the AC input signal. The amplitude of this voltage step can cause significant issues, e.g., on component wear.

Moreover, if operating in a QSW mode (and in the absence of the herein proposed boost input decoupler) a reverse current is induced in a corresponding forward biased rectifying component (e.g., the corresponding rectifying diode) per each switching cycle of the synchronous boost PFC converter. This can cause, if one or more rectifying diodes are used, a voltage step of several volts at the first input node. This would give rise to continuous high frequency excitations of the input interface.

Conventional totem pole designs overcome these issues by employing MOSFETs (rather than diodes) to perform the rectification by the rectifying system. These MOSFET are kept conductive during the entire respective mains half cycle.

In the proposed scheme, the large voltage step is handled using the proposed boost input decoupler. This decoupler also greatly relaxes the second (HF, LV) effect.

If, however, the voltage at the first input node is controlled, then these input capacitances do not appear as PFC input capacitances albeit effectively relieving the EMI filter. In this way, the capacitance of the filtering capacitor can be much smaller.

In preferred examples, the synchronous boost PFC converter comprises a control system for controlling the operation of the switches using a quasi-square wave control technique. The quasi-square wave technique facilitates or allows higher switching frequency of the first and second switch compared to other existing techniques. The proposed system allows for QSW mode operation.

In some examples, the synchronous boost PFC converter comprises a transition control system for controlling the operation of the first and second switches during a positive-to-negative zero crossing of the voltage provided by the AC input signal.

The transition control system may be configured to, during a positive-to-negative zero crossing of the voltage provided by the AC input signal, control the voltage at the first input node, by controlling the operation of the first and second switches, to reach a high voltage level.

This approach prevents the voltage at the input to the synchronous boost PFC converter not being left uncontrolled. Conceptually, at this location, during conventional control of the synchronous boost converter, large voltage steps would occur twice per period of the AC input signal. Each of these large voltage step would have a voltage as large as the voltage at the first output node. This can cause unexpected errors or operations of the PFC system. In particular, this can cause excessive or destructive currents in the boost converter and as well as excitation of excessive ringing in rectifying system and the EMI filter (when present).

By controlling the voltage at this node to reach the voltage at the first output in two or more steps during the transition, then a larger voltage step can be avoided. This reduces the current flowing through the inductor of the synchronous boost PFC converter, increasing a robustness and stability of this inductor.

The transition control system may be configured to, during a positive-to-negative zero crossing of the voltage provided by the AC input signal, control the voltage at the first input node to reach the high voltage level before the power provided by the AC input signal to the second input node is able to forward bias the first rectifying diode.

The transition control system may be configured to, during a positive-to-negative zero crossing of the voltage provided by the AC input signal, control the voltage at the first input node to reach the high voltage level by resonantly charging the first input node via the inductor of the synchronous boost converter.

The transition control system may be configured to, during a positive-to-negative zero crossing of the voltage provided by the AC input signal, control the voltage at the first input node to reach the high voltage level, wherein the control is configured such that the magnitude of the current through the inductor of the synchronous boost converter remains below a threshold current.

The transition control system may be configured to, during the positive-to-negative zero crossing of the voltage provided by the AC input signal, control the voltage at the first input node, by controlling the operation of the first and second switches, to reach the high voltage level in two or more voltage steps.

In some examples, the transition control system is configured to, during a positive-to-negative zero crossing of the voltage provided by the AC input signal: enter a first control phase during which the transition control system controls the operation of the first and second switch such that the voltage at the first input node is maintained; after the first control phase, enter a second control phase during which the transition control system controls the operation of the first and second switch such that the voltage at the first input node reaches the high voltage level; and after the voltage at the first input node reaches the high voltage level, enter a third control phase during which the transition control system controls the operation of the first and second switch such that the voltage at the first input node is maintained at the high voltage level.

In some examples, the transition control system is further configured to control the operation of the first and second switches during a negative-to-positive zero crossing of the voltage provided by AC input signal.

The transition control system may be configured to, during a negative-to-positive zero crossing of the voltage provided by AC input signal, control the voltage at the first input node, by controlling the operation of the first and second switches, to reach a low voltage level.

In some examples, the transistor control system is configured to, during a negative-to-positive zero crossing of the voltage provided by AC input signal: enter the third control phase; after the third control phase, enter the second control phase; and after the second control phase, enter the first control phase.

The transistor control system may be configured to, during a negative-to-positive zero crossing of the voltage provided by AC input signal: enter a fourth control phase during which the transition control system controls the operation of the first and second switch such that the voltage at the first input node is maintained; after the fourth control phase, enter a fifth control phase during which the transition control system controls the operation of the first and second switch such that the voltage at the first input node reaches the low voltage level; and after the voltage at the first input node reaches the low voltage level, enter a sixth control phase during which the transition control system controls the operation of the first and second switch such that the voltage at the first input node is maintained at the low voltage level.

In some examples, the transition control system is configured to, during the negative-to-positive zero crossing of the voltage provided by the AC input signal, control the voltage at the first input node, by controlling the operation of the first and second switches, to reach the low voltage level in two or more steps.

Optionally, the transition control system is configured to control the operation of the first and second switches responsive to the magnitude of the voltage provided by the AC input signal falling below a first predetermined threshold. This can be used to prevent the voltage at the input to the synchronous boost PFC converter from falling a minimum operational voltage for performing a boost function, thereby increasing the reliability of the system.

The transition control system may be configured to relinquish control of the operation of the first and second switches responsive to the magnitude of the voltage provided by the AC input signal rising above the first predetermined threshold.

In some examples, the transition control system is configured to, during a positive-to-negative zero crossing of the voltage provided by the AC input signal, control the voltage at the first input node, by controlling the operation of the first and second switches, to reach the voltage at the first output node in three or more steps.

In some examples, during the first control phase, the transition control system controls the operation of the first and second switch such that the voltage at the first input node is maintained at a predetermined voltage level.

Preferably, the capacitance of the output capacitor is more than 100 times greater than the capacitance of the first decoupling capacitor and/or the second decoupling capacitor.

In some examples, the first and/or second switch of the synchronous boost PFC converter comprises a MOSFET. By way of example, the MOSFET may be a silicon or, more preferably, SiC MOSFET. In some other examples, the first and/or second switch of the synchronous boost PFC converter is an FET such as a GaN HEMT.

There is also proposed an electronic device arrangement comprising: an electronic device configured to draw less than 10 kW; and any herein proposed totem pole power factor correction system.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates an existing totem pole power factor correction circuit;

FIG. 2 illustrates a proposed totem pole power factor correction circuit;

FIG. 3 illustrates waveforms at various nodes within the proposed or existing totem pole power factor correction circuit;

FIG. 4 illustrates waveforms during at zero crossings of an AC input signal for a proposed control scheme;

FIG. 5 provides a state plane diagram for an inductor of a synchronous boost PFC converter used in a proposed totem pole power factor correction circuit; and

FIG. 6 illustrates the current into the inductor and an output capacitor during a transition.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a totem pole power factor correction system that makes use of rectifying diodes in the rectifying system and comprises a synchronous boost PFC converter. The mechanism comprises a boost input decoupler, formed of a pair of clamping diodes and decoupling capacitors, that decouples the input of the synchronous boost PFC converter from an input interface (which receives an AC input signal for conversion).

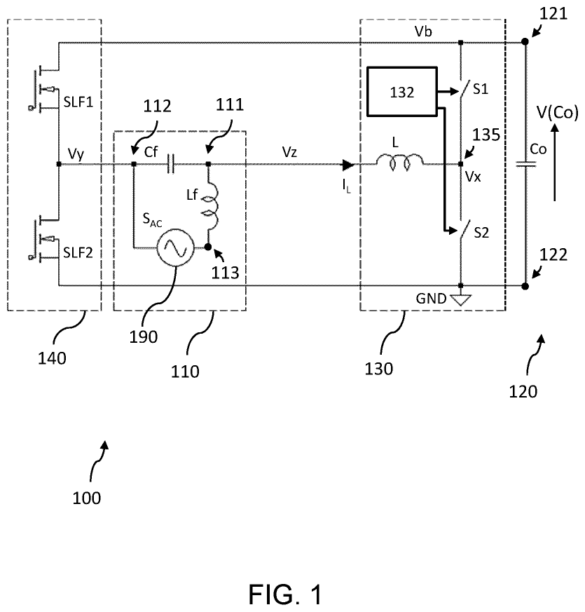

FIG. 1 illustrates an existing totem pole power factor correction system 100 to aid in contextualizing the present invention.

The system 100 comprises an input interface 110 comprising a first input node 111 and a second input node 112 for receiving an AC input signal S_{AC} from an external power supply 190. The input interface 110 comprises an impedance connecting the first and second inputs nodes, here: a filtering capacitor Cf.

The input interface may comprise an EMI filter for performing EMI filtering (i.e., electromagnetic interference filtering) on the AC input signal received by the input interface. The intention of the EMI filter is to supress or attenuate any interferences generated the power factor correction system 100 to remain below a permitted level to which the external power supply may be exposed. The EMI filter comprises the filtering capacitor Cf connected between the first input node 111 and the second input node 112 and a filtering inductor Lf connected between the first input node 111 and a third input node 113. The input interface 110 is configured such that the AC input signal S_{AC} is received between the second input node 112 and the third input node 113.

Of course, the EMI filter may contain extra filtering components, as is well established in the art. The illustrated EMI filter describes what are usually considered to be the minimum components required for effectively performing EMI filtering of differential mode noise.

The system 100 also comprises an output interface 120 for providing a driving signal V (Co) to a load (not shown). The output interface 120 comprises a first output node 121 and a second output node 122 for connecting to the load. The output interface 120 also comprises an output capacitor Co connected between the first output node 121 and the second output node 122.

The voltage V(Co) between the first output node 121 and the second output node 122 is a bus voltage Vb. The second output node 122 is connected to a ground GND or reference voltage, and is therefore at a ground voltage GND.

The system 100 also comprises a synchronous boost PFC converter 130 comprising an inductor L coupled between the first input node 111 and an intermediate node 135. The synchronous boost PFC converter 130 also comprises a first switch S1 connected between the intermediate node 135 and the first output node 121; and a second switch S2 connected between the intermediate node 135 and the second output node 122.

An alternative label for the first input node 111 is a boost input node 111. An alternative label for the second input node 112 is a rectifier node 112. An alternative label for the first output node 121 is a bus node 121. An alternative label for the second output node 122 is a ground node 122. An alternative label for the intermediate node 135 is a switch node 135, or a boost converter switch node 135.

The voltage Vz at the first input node 111 can be labelled a boost input voltage Vz. The voltage Vy at the second input node 112 can be labelled a rectifier node voltage Vy. The voltage Vb at the first output node 121 can be labelled a bus voltage Vb. The voltage at the second output node 122 can be labelled a ground voltage GND. The voltage Vx at the intermediate node 135 can be labelled an intermediate voltage Vx or a switch voltage Vx.

These labels will be used interchangeably throughout this description.

The system also comprises a rectifying system 140 comprising: a first rectifying switch SLF1 connected between the second input node 112 and the first output node 121; and a second rectifying switch SLF2 connected between the second output node 122 and the second input node 112. Each rectifying switch may, for instance, be a MOSFET.

The totem pole arrangement for the rectifying system 140 is able to reduce losses in the rectifying system. Compared to a more conventional rectifying system (which makes use of a full bridge diode rectifier), to ensure low-loss operation, the AC input signal current S_{AC} should be controlled to only flow through a single rectifying switch at a time. This can be achieved through appropriate control of the switches, e.g., to operate the switches SLF1, SLF2 to operate/switch at the frequency of the AC input signal S_{AC}.

Because of this relatively low frequency operation procedure, the relatively large output capacitance of the rectifying switches has previously been considered unimportant. It is also relatively common to label the rectifying switches “low-frequency switches”.

A synchronous boost PFC converter 130 can be controlled in at least four operation modes, which are well-known to the skilled person. These modes include: the continuous conduction mode (CCM), the discontinuous conduction mode (DCM), the boundary/transition conduction mode (BCM) and the quasi-square wave (QSW) mode. The quasi-square wave mode is sometimes labelled the triangular current mode.

In particular, a control system 132 of the synchronous boost PFC converter 130 may be configured to control the switching of the first S1 and second S2 switches according to one of these modes. The choice of mode may be dependent upon design requirements or user preference.

Generally, the control system 132 is configured so that only one of the first S1 and second S2 switches is conductive at a same time, leading to synchronous control. More particular, the control system may be configured such that current is always able to flow between the intermediate node 135 and the first output node 121 or the second output node 122.

Approaches for controlling a synchronous boost PFC converter 130 according to a CCM are well-established. Example approaches are disclosed by Zhou, Bo. CCM totem pole bridgeless PFC with ultra fast IGBT. Diss. Virginia Tech, 2014 and Huang, Qingyun, and Alex Q. Huang. “Review of GaN totem-pole bridgeless PFC.” CPSS Transactions on Power Electronics and Applications 2.3 (2017): 187-196. Another approach is disclosed by Mai, Leonardo S., et al. “Totem-Pole Bridgeless PFC Converter in DCM with Synchronous Rectification.” 2019 IEEE 15th Brazilian Power Electronics Conference and 5th IEEE Southern Power Electronics Conference (COBEP/SPEC). IEEE, 2019.

Approaches for controlling a synchronous boost PFC converter 130 according to a DCM are also well-established. Example approaches are disclosed by Mai, Leonardo S., et al. “Totem-Pole Bridgeless PFC Converter in DCM with Synchronous Rectification.” 2019 IEEE 15th Brazilian Power Electronics Conference and 5th IEEE Southern Power Electronics Conference (COBEP/SPEC). IEEE, 2019.

Approaches for controlling a synchronous boost PFC converter 130 according to a boundary conduction mode are established. For instance, one approach is disclosed by Huber, Laszlo, Brian T. Irving, and Milan M. Jovanovic. “Open-loop control methods for interleaved DCM/CCM boundary boost PFC converters.” IEEE Transactions on Power Electronics 23.4 (2008): 1649-1657. Another approach is disclosed by Choi, Hangseok, and Laszlo Balogh. “A cross-coupled master-slave interleaving method for boundary conduction mode (BCM) PFC converters.” IEEE Transactions on Power Electronics 27.10 (2012): 4202-4211. Yet another approach is suggested by Su, Bin, Junming Zhang, and Zhengyu Lu. “Totem-pole boost bridgeless PFC rectifier with simple zero-current detection and full-range ZVS operating at the boundary of DCM/CCM.” IEEE Transactions on Power Electronics 26.2 (2010): 427-435.

Approaches for controlling a synchronous boost PFC converter 130 according to a quasi-square wave mode are established in the art, as disclosed by “Vorpérian, Vatché. “Quasi-square-wave converters: topologies and analysis.” IEEE Transactions on Power Electronics 3.2 (1988): 183-191 and C. Margit, J. Biela, and J. W. Kolar, “Interleaved triangular current mode (TCM) resonant transition, single phase PFC rectifier with high efficiency and high power density”, Proc. Int. Power Electronics Conf., ECCE ASIA, June 2010, pp. 1725-1732.)

One issue with CCM, DCM and BCM is that they all exhibit hard switching over at least part of the operation range. On the contrary, the QSW mode facilitates or provides zero voltage switching (ZVS) over the entire load and input voltage range, therefore allowing the highest switching frequencies without damaging the first and second switches and/or affecting efficiency.

Operating in the quasi-square wave mode results in larger values, e.g., larger root mean square values, for currents at the first input node 111 and the intermediate node 135. This means that higher efficiencies for the converter 130 require ever-smaller output capacitances of the switches S1 and S2. This requires the use of more advanced switches, e.g., formed of more advanced and expensive materials (such as SiC or GaN) rather than standard silicon (Si).

Regardless of the mode of operation of the synchronous boost PFC converter 130, the rectifying switches SLF1, SLF2 are typically operated as synchronous rectifiers in the third quadrant of their output characteristic. Nonetheless, even if the rectifying switches were permanently kept in OFF mode, their body diodes would still be able to provide the necessary rectifier functionality. Thus, it is conceptually possible to replace each rectifying switch with a rectifying diode. This would be advantageous, as rectifying switches are more materially expensive than rectifying diodes, and require additional gate driving and control circuitry.

However, under present systems, successful replacement of both rectifying switches with rectifying diodes can only be achieved (with a low/acceptable level of noise) for the CCM or DCM.

In particular, if the synchronous boost PFC converter 130 operates in the QSW mode, the instantaneous current at the second input node 112 will go negative and could reverse bias one of the rectifying diodes. In particular, a rectifying diode replacing SLF1 could be reverse biased in the negative half-cycle of the AC input signal S_{AC} and a rectifying diode replacing SLF2 could be reverse biased in the negative half-cycle of the AC input signal S_{AC}. This effect is particularly pronounced when the average AC input signal current is low. This reverse biasing effect can cause both common and differential mode noise.

At present, if QSW mode operation is desired, the approach to address this reverse biasing effect or problem is to preserve the use of the rectifying switches SLF1, SLF2 to form the rectifying arrangement 140 (i.e., rather than rectifying diodes). Here, the relevant rectifying switch is kept conducting throughout the respective mains half cycle keeping the voltage at the second input node at a ground voltage GND or the bus voltage Vb.

Some of the disadvantages of using rectifying switches have previously been described, and include more expensive material cost and the need for extra gate driving and control means/circuitry. Moreover, the conduction losses of such switches can only be kept below those of diodes if relatively large devices are employed. Large devices come with large output capacitances and ringing of the nodes first 111 and second 112 input nodes can result from the switching of the rectifying switches at the mains voltages zero crossings. Furthermore, all/any ripple current of the AC input signal must pass the EMI filter, which can lead to inconveniently large filter components and a non-unity cosine phi, especially with high-impedance or light loads.

The present disclosure provides a technique for overcoming these issues, allowing for rectifying diodes to replace the rectifying switches SLF1, SFL2 whilst still allowing the synchronous boost PFC converter to be operated in a QSW mode to enable a high switching frequency. Proposed approaches also permit the size of the EMI filter to be significantly reduced.

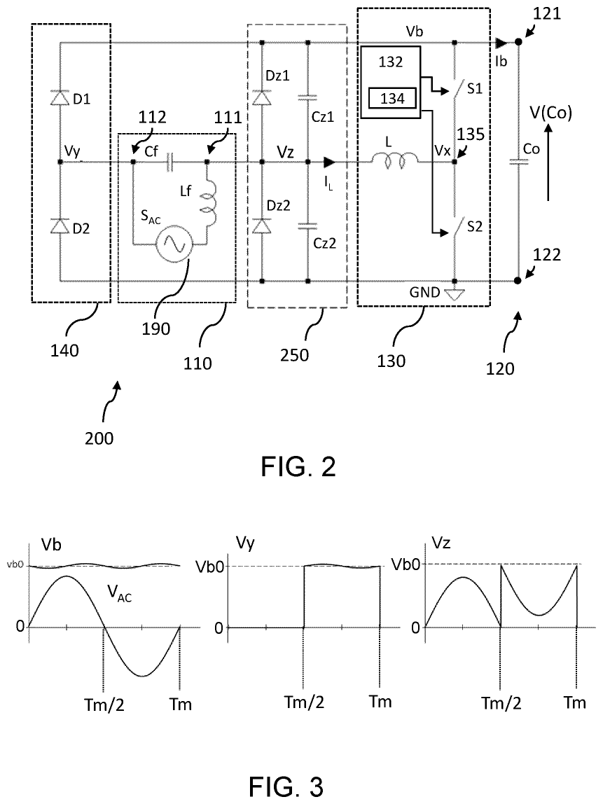

FIG. 2 illustrates a totem pole power factor correction system 200 according to a proposed approach. For the sake of conciseness, only those elements that differ from the previously described system 100 are described and indicated.

The switches S1 and S2 may, for this approach, be embodied as MOSFETs, although other suitable types of switches will be apparent to the skilled person.

The rectifying switches (of the previously described system 100) have been replaced with rectifying diodes D1, D2.

The system 200 also comprises a boost input decoupler 250 comprising a first clamping diode Dz1 connected between the first input node 111 and the first output node 121; and a second clamping diode Dz2 connected between the second output node 122 and the first input node 121.

The boost input decoupler 250 also comprises a first decoupling capacitor Cz1 connected between the first input node 111 and the first output node 121; and a second decoupling capacitor Cz2 connected between the first input node 111 and the second output node 122. One of these decoupling capacitors may be omitted in some variants of this embodiment.

Thus, if present, the first clamping diode Dz1 and the first decoupling capacitor Cz1 are connected in parallel to one another, just as the second clamping diode Dz2 and the second decoupling capacitor Cz2 are connected in parallel to one another.

The proposed approach thereby decouples the boost input Vz from the rectifying system 140 and the EMI filter Cf, Lf. This prevents the rectifying diodes D1, D2 from becoming reverse biased.

In particular, the boost input decoupler offers an additional or alternative current path for any high frequency current ripple. Thus, this ripple current no longer needs to flow through the rectifier diode(s) D1, D2 which means that they can stay forward biased.

More particularly, to reduce an effect of current flow into the rectifier node 112, one or more decoupling capacitors are provided such that current will flow toward the capacitor(s), rather than the rectifier node 122. This can be achieved by defining the capacitance of each decoupling capacitor to be much larger (e.g., more than 100 times larger) than the junction capacitance of the rectifying diodes.

It is also recognized that it would be preferable if the boost input voltage Vz (and consequently, the rectifier node voltage Vy) is not left uncontrolled. Sudden or abrupt voltage changes could be significant in the first input node 111 and/or the second input node 112, particularly at transitions or zero crossings of the AC input signal. At these transitions, the magnitude of the voltage step can reach the magnitude of the bus voltage Vb. Thus, there may be a voltage step, at the first input node 111, of no less than the bus voltage twice per period of the AC input signal S_{AC} if the boost input voltage Vz is left uncontrolled. This would lead to large currents and ringing of the entire input interface. For the proposed technique, this could result in considerable losses due to the additional capacitances of the one or more decoupling capacitors Cz1, Cz2 of the boost input decoupler 250.

These voltage steps result from the control of the converter 130 according to known or existing control schemes.

More particularly, it is inevitable that (at the rectifier node 112) there will be a voltage step between the bus voltage Vb and the ground/reference voltage GND (or vice versa) when the AC input signal undergoes a zero crossing. This holds true regardless of which of systems 100 or 200 is used. This is because the periodically inverting AC input signal will, when crossing zero, change which rectifying device (e.g., rectifying switch or rectifying diode) is forward biased. Thus, the voltage Vy at the rectifier node 112 will inevitably switch between the bus voltage Vb and the ground/reference voltage GND.

The effect of this voltage step at the rectifier node 112 is ringing of the input interface. The resultant ringing becomes worse if/when one or more decoupling capacitors Cz1, Cz2 are coupled to the first input node 111. This is because the voltage at the first input node 111 would, in conventional circumstances, follow the voltage step at the rectifier input node 112. This means that there would be an extremely high current through (and therefore a high voltage across) the filtering capacitor Cf (or other impedance connecting the first input node 111 to the second input node 112).

It has been identified that the boost input voltage Vz could be controlled such that, after zero crossings of the mains AC signal, there is not a significant voltage difference across the EMI filter capacitor Cf. This would reduce/attenuate any noise/ringing of the input interface at the zero crossings of the AC mains signal.

It has also been identified that if the boost input voltage Vz is appropriately controlled to avoid or reduce these large voltage steps, then the decoupling capacitors provide effectively no input capacitance to the synchronous boost PFC converter 130, thereby avoiding or mitigating any losses through the additional capacitances.

Moreover, the additional capacitances provided by the decoupling capacitors can be taken into account to reduce the size of the EMI filter capacitor Cf. Put another way, the additional capacitances can be used to at least partially perform the function of the EMI filter capacitor in the EMI filter. This means that the size of the EMI filter can be significantly reduced.

For improved contextual understanding, FIG. 3 illustrates idealized waveforms of the system 100 or 200 plotting the voltage V_{AC} of the AC input signal S_{AC} provided to the first input node 111, the first input node voltage Vz and the second input node voltages Vz, switching at twice the mains frequency, and the bus voltage Vb.

FIG. 3 illustrates a single cycle of the AC input signal S_{AC}, which has a period of Tm, such that there is a zero crossing of the voltage of the AC input signal S_{AC} every Tm/2.

In particular, FIG. 3 illustrates the normal or conventional control scheme for the system 100 or the system 200. This more clearly demonstrates the significant voltage steps (on the voltage Vz at the first input node and the voltage Vy at the second input node) that occur at zero crossings or transitions of the AC input signal S_{AC}.

During conventional operation (specifically, between zero crossings of the AC input signal S_{AC}), the synchronous boost PFC converter is used to control the (average) bus voltage Vb and the current of the AC input signal. This can be performed, for instance, using cascaded feedback control loops.

In particular, the control system 132 may perform the control of the switches S1, S2 in order to control the bus voltage Vb and the current of the AC input signal S_{AC}. This control may be performed to be proportional to the AC input voltage and preferably, rendering a unity power factor. Preferably, this is carried out using a QSW mode of control, which has been previously described.

Although relevant for the overall PFC performance in terms of the achievable power factor, these control aspects are not detailed as they are reasonably well established in the field of power factor control. Typically, control of the boost input voltage Vz can be achieved by measuring the boost input voltage Vz and maintaining boost input voltage to reach a desired voltage. Feedback for control of the current of the AC input signal can performed by monitoring the boost current I_{L}, i.e., the current of the signal at the first input node 111. Alternatively, the current of the AC input signal could be measured directly e.g., in the rectifying diodes D1 and D2, e.g., using shunts referring to either ground or the bus voltage.

The present disclosure also proposes a transition control system 134 for controlling the operation of the first and second switches during a zero crossing or transition of the voltage provided by the AC input signal. Thus, the transition control system 134 controls the operation of the first and second switches during transitions between positive and negative voltages, as well as transitions between negative and positive voltages.

The transition control system 134 may, for instance, form part of the overall control system 132 of the synchronous boost PFC converter 130. However, in other examples, the transition control system 134 is formed as a separate entity.

The proposed transition control system 134 can be configured to attenuate, mitigate or reduce the occurrence of a large voltage difference or drop across the EMF filter capacitor Cf or other impedance coupling the first and second input nodes. This is achieved by controlling the voltage Vz at the boost input node 111 at/during transitions from the positive-negative voltages or negative-positive voltages of the AC input signal S_{AC}.

In particular, at a transition of the AC input signal S_{AC} the transition control system 134 can be configured to commutate the boost input voltage Vz at the boost input node 111 by controlling the first S1 and second S2 switches. The voltage Vy at the rectifier node 112 will follow the boost input voltage Vz (as the boost input voltage effectively acts as a power supply), via the impedance Cf. In other words, the transition control system 134 controls the boost input voltage Vz as a leading voltage, whereas the rectifier node voltage Vy is a lagging voltage (relative to the boost input voltage).

By commutating the voltage Vz at the boost input node 111 and the voltage Vy at the rectifier node, the large voltage difference across the EMF filter capacitor, that was previously induced by the transition of the mains current, is avoided. This significantly reduces noise and ringing in the input interface.

Using the first and second switches S1 and S2 to control the voltage at the boost input node 111 (and thereby the voltage at the rectifier node 112) will control these voltages to have a less steep slope/gradient than would be provided if left uncontrolled, e.g., were left to respond to the AC input signal alone.

This control scheme handles and controls the transition of the voltage at the boost input node 111 to avoid/reduce both losses and ringing.

The control scheme also facilitates low voltage switching at the second input node 112, further reducing noise and/or ringing.

More particularly, the sources of both differential and common mode interferences are attenuated. Differential mode interference is reduced by keeping the current across impedance Cf relatively low (i.e., by avoiding a sudden voltage drop across the impedance Cf). Common mode interference is reduced by lowering the steepness of the voltage transition at the boost input node 111 and the rectifier node 112.

This means that the size and/or component value(s) of the EMI filter can be reduced, compared to that previously available.

The transition control system 134 is configured to control the operation of the first S1 and second S2 switches responsive to the magnitude of the voltage provided by the AC input signal S_{AC} falling below a first predetermined threshold. This would indicate that there is an upcoming transition between a positive and negative voltages (or vice versa) of the AC input signal S_{AC}.

Similarly, the transition control system may be configured to relinquish control of the operation of the first and second switches responsive to the magnitude of the voltage provided by the AC input signal rising above the first predetermined threshold.

It will be apparent that the transition control system may effectively “override” the normal operation of the synchronous boost PFC converter 130 during transition periods. Thus, the control system 132 may comprise a normal control system (not shown) for controlling the operation of the switches S1, S2 in between transitions or in between periods during which the transition control system 134 performs the control of the operation of the first and second switches.

The transition control system is configured to, during a (e.g., any/all) positive-to-negative zero crossing of the voltage provided by the AC input signal to the first input node, control the voltage at the first input node, by controlling the operation of the first and second switches, to reach a high voltage level.

This approach thereby increases the voltage Vz at the first input node 111 using the first and second switches. This is achieved by controllably connecting the intermediate node 135 to the first output node 121. The voltage at the intermediate node 135 in turn charges the first input node 111. Thus, the transition control system is configured to charge the voltage Vz at the first input node 111 using the voltage V(Co) across the output capacitor Co, via the first and/or second switches.

The rectifier node voltage Vy will follow the boost input voltage Vz. By controlling the boost input voltage Vz to reach the high voltage level, this will similarly control the rectifier node voltage Vy to reach this high voltage level.

The high voltage level may be the bus voltage Vb or a biased version of the same, e.g., Vb−Vbi (where Vbi is a biasing voltage). The biasing voltage may be the minimum boost input voltage Vzₘᵢₙ, which represents a minimum input to the boost PFC converter 130 for achieving zero voltage switching control of the boost PFC converter.

The minimum boost input voltage Vzₘᵢₙ is defined by the minimum duty cycle and can be estimated by the equation:

$${Vz}_{min} = 2 {fs}_{min} \sqrt{2 Qoss \cdot L \cdot {V}_{b}} \qquad ( 1 )$$

Qoss is the output charge of the switches S1 and S2, L is the boost inductance, and fsₘᵢₙ is the minimum operating frequency of the switches S1, S2. The minimum operating frequency is a design choice and may be adapted e.g., to the control loop of the boost input voltage. Equation (1) assumes that the synchronous boost PFC converter 130 is to be run with the minimum rms current needed to ensure zero-voltage switching (ZVS) of the intermediate node 135.

By way of example only, Vzₘᵢₙ is about 16V at an average bus voltage Vb0 of 700V, with fsₘᵢₙ=150 kHz, Qoss=50 nC, L=40 μH, V_{b}=700V. For practical reasons the threshold chosen is 20V.

It will be appreciated that the minimum boost input voltage Vzₘᵢₙ can be decreased by further decreasing fsₘᵢₙ. For instance, fsₘᵢₙ is usually considered to be about 10% of the maximum rated frequency.

Preferably, the transition control system is configured, during a (e.g., any) positive-to-negative zero crossing of the voltage provided by the AC input signal to the first input node, control the voltage Vz at the first input node 111 to reach the high voltage level before the power provided by the AC input signal to the second input node is able to forward bias the first rectifying diode.

As the rectifier node voltage Vy follows the boost input voltage Vz, the rectifier node voltage Vy is thereby similarly controlled to reach the high voltage level before the power provided by the AC input signal to the second input node is able to forward bias the first rectifying diode.

This facilitates zero or low voltage switching of the second input node 112 (the rectifier node 112), i.e., zero or low voltage switching when the AC input signal changes so as to forward bias the first rectifying diode (bringing the rectifier node voltage Vy to or near the bus voltage Vb). This approach significantly reduces noise and/or ringing in the input interface.

The transition control system 134 is preferably configured to, during a (e.g., any) positive-to-negative zero crossing of the voltage provided by the AC input signal to the first input node, control the voltage at the first input node 111 to reach the high voltage level by resonantly charging the first input node via the inductor of the synchronous boost converter.

This approach effectively “soft-charges” the voltage at the input node, so that it is gradually increased over time, rather than being abruptly stepped to the high voltage level. This reduces a noise in the overall power factor correction system. Put another way, this approach effectively avoids a rapid voltage step in/at the first input node, instead configuring the voltage change at the first input node to be a resonant transition with well-defined component values, and thus a well-defined steepness/rate of change of the voltage Vz at the first input node 111.

The transition control system 134 may be configured to, during a positive-to-negative zero crossing of the voltage provided by the AC input signal to the first input node, control the voltage at the first input node to reach the high voltage level, wherein the control is configured such that the magnitude of the current I_{L} through the inductor L of the synchronous boost converter 130 remains below a threshold current I_{TH}.

The threshold current I_{TH} is preferably below a saturation current I_{SAT} of the inductor L. The threshold current I_{TH} may represent a maximum permissible current through the inductor L to avoid noise or ringing at the first input node 111.

The maximum possible current I_{L-PK} in the inductor can be defined by the following equation:

$${I}_{L - PK} = BF \cdot Vb \sqrt{\frac{Cz}{L}} \qquad ( 2 )$$

where (for the purposes of equation 2), Cz is the total capacitance of the decoupling capacitor(s) and L is the inductance of the inductor L. Thus, if the decoupling capacitor(s) comprise a first Cz1 and second Cz2 decoupling capacitor, then Cz=Cz1+Cz2—where Cz1 represents the capacitance of the decoupling capacitor Cz1 and Cz2 represents the capacitance of the decoupling capacitor Cz2. BF is a biasing factor, e.g., sqrt (¾)—valid for linear capacitors, other component types would influence the biasing factor accordingly.

The threshold current may be set to be equal to a value less than or equal to the maximum possible current I_{L-PK}, e.g., a predetermined fraction of the maximum possible current I_{L-PK}.

This approach aims to perform a lossless or near-lossless voltage transition of the first input node 111, as well as keeping/preserving ZVS of the synchronous boost PFC converter 130.

The control of the first and second switches, to maintain the current I_{L} below the threshold current I_{TH}, may make use of a modulated control of the voltage Vx at the intermediate node 135. In particular, the voltage at the intermediate node 135 may be controlled to perform one or more switching cycles to move the boost input voltage Vz to the high voltage level.

In addition to using a maximum possible current I_{L-PK} in the inductor, a maximum rate of change of the voltage at the boost input node dVz/dt can be defined, which also results in a minimum number of switching cycles. The respective largest number of cycles may then be chosen.

A switching cycle includes a connection phase and a disconnection phase. A connection phase comprises connecting the intermediate node 135 to the first output node 121 (and disconnecting the intermediate node from the second output node 122), to thereby charge/increase the boost input voltage and increase the magnitude of the current I_{L} through the inductor. A disconnection phase comprises connecting the intermediate node 135 to the second output node 122 (and disconnecting the intermediate node from the first output node) to dissipate the current through the inductor L.

The connection phase may be held until the magnitude of the inductor current I_{L} reaches, or is predicted to reach, the threshold current. The disconnection phase may be held until the magnitude of the inductor current I_{L} reaches, or is predicted to reach, 0 or a minimum current for zero voltage switching of the boost converter.

The number of switching cycles required to commute the voltage at the boost input node may depend upon the characteristics of the decoupling capacitor(s) Cz1, Cz2 and/or the inductor L. Control of the second control phase may use a pre-defined switching pattern if the involved circuit parameters are known. In particular, if the inductance of inductor L as well as the capacitance of the decoupling capacitors Cz1, Cz2 (and optionally the junction capacitance of the rectifying diodes D1 D2, Dz1 and Dz2, and the filter capacitor Cf) are known, then a switching pattern for achieving a transition of the voltage Vz at the first input node 111 to the high voltage level, without the current through the inductor L exceeding the threshold current), can be determined in advance.

Alternatively, the boost input voltage Vz and/or the inductor current I_{L} can be compared with pre-set threshold values to generate the switching signals for the switches S1, S2 to move the boost input voltage Vz to the high voltage level without the current I_{L} through the inductor L exceeding the threshold current I_{TH}.

In order to ensure that the magnitude of the current I_{L} remains below the threshold current, it may be necessary to perform a controlled switching of the first and second switches, e.g., so that the voltage Vz at the first input node 111 is incrementally charged or increased. This requirement may, for instance, depend upon the precise component values of the components in the boost PFC converter.

In this way, the transition control system 134 is configured to, during a positive-to-negative zero crossing of the voltage provided by the AC input signal, control the voltage at the first input node, by controlling the operation of the first and second switches, to reach the voltage at the first output node in two or more steps.

Thus, the transition of the boost input voltage to the high voltage level can be effectively split into a series of smaller voltage steps. This approach facilitates specific control of the peak value of the inductor current I_{L} during the transition (i.e., during a zero crossing of the AC input signal), to thereby reduce or attenuate oscillations at the boost input node 111).

It will be apparent that the minimum number of steps may be defined by the maximum allowable current in the inductor L. In particular, the maximum allowable current may be defined that the inductor L is not permitted to saturate, which would cause even higher currents that could, in turn, destroy the inverter. The more steps are, used the lower is the inductor current I_{L}.

The transition control system 134 may be configured to, during a positive-to-negative zero crossing (i.e., a transition) of the voltage provided by the AC input signal, perform a three-phase sequence of steps or control phases. Thus, during a transition from a positive-to-negative voltage of the AC input signal, the transition control system may be configured to operate in a first control phase, then a second control phase, then a third control phase.

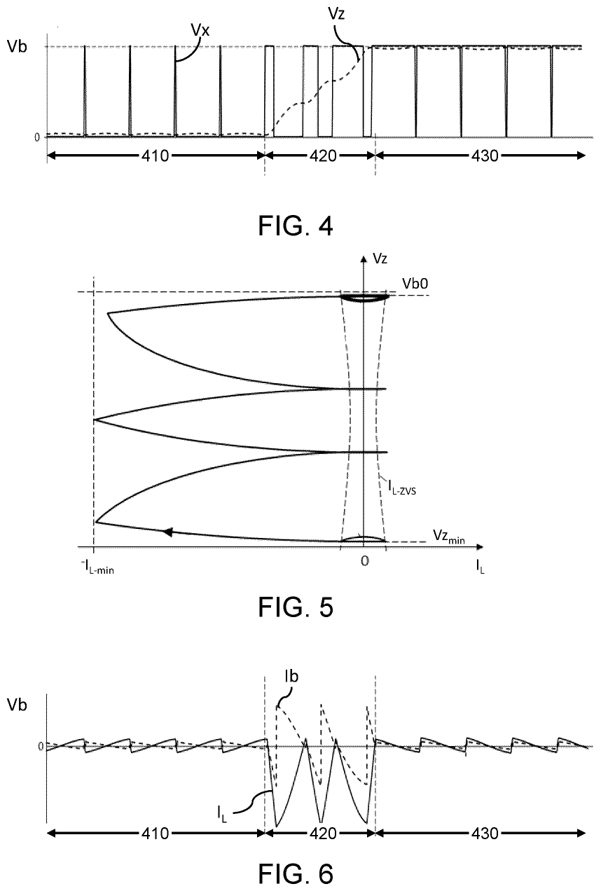

FIG. 4 illustrates the voltage waveforms at the first input node 111 (voltage Vz) and the intermediate node 135 (voltage Vx) during the first 410, second 420 and third 430 control phases-during a positive-to-negative zero crossing—for improved understanding.

In the first control phase 410, the transition control system may control the operation of the first and second switch such that the voltage at the first input node is maintained (e.g., at the level when entering the first control phase, which may be a minimum boost input voltage).

In the second control phase 420, the transition control system may control the operation of the first and second switch such that the voltage at the first input node reaches the high voltage level. This will, correspondingly, bring the voltage at the second input node to the high voltage level.

Approaches for performing the second control phase have been previously explained. The second control phase thereby represents the phase during which the voltage at the first input node 111 is brought to the high voltage level.

As previously explained, the second control phase may take place using two or more steps. This can be carried out through appropriate control of the switches such that the intermediate node is modulated such that the voltage at the first input node 111 gradually steps up to the voltage Vb at the first output node 121 in two or more steps, e.g., three or more steps.

However, e.g., depending upon component values, it is not essential that the voltage at the first input node be incremented in a plurality of steps- and some embodiments may only require a single step.

In particular, during the second control phase, the transition control system may be configured to connect the intermediate node 135 to the first output node 121 for increasingly longer periods of time. This will cause the voltage at the first input node 111 to gradually step up to the voltage at the first output node 121.

In the third control phase 430, the transition control system may control the operation of the first and second switch such that the voltage at the first input node is maintained at the voltage Vb of the first output node 121.

During positive-to-negative zero crossings, the transition control system may enter the first control phase when the voltage of the AC input signal S_{AC} falls below a first predetermined voltage. This may override a conventional or normal operation of the switches S1, S2.

During positive-to-negative zero crossings, the transition control system may move from the first control phase to the second control phase at any point after the voltage of the AC input signal falls below 0V, i.e., performs the zero crossing. This can be performed by monitoring or measuring the voltage of the AC input signal, or may simply be performed after a period of time after initiating the first control phase following which the voltage of the AC input signal is likely to have fallen below 0. Meeting the exact zero crossing is not necessary as the converter is decoupled via the boost input decoupler and/or the voltage at the boost input node 111 is controlled.

During positive-to-negative zero crossings, the transition control system may move from the second control phase to the third control phase responsive to the voltage at the first input node reaching the voltage at the first output node or the voltage at the first output node minus a biasing value (e.g., the first input node reaching a maximum boost input voltage).

During the first and third control phases, which are both effectively “idle modes” during voltages are maintained, the transition control system is configured to maintain/perform periodic switching of the switches S1 and S2. This increases an ease and smoothness with restarting a switching process (e.g., for the second phase or for entering normal operation) because of the oscillating energy involved.

It will be appreciated that the first and/or third phases may be omitted in some embodiments.

As previously explained, for a positive-to-negative zero crossing of the voltage of the AC input signal, the first control phase may be initiated responsive to voltage of the AC input signal S_{AC} falling below a first predetermined voltage. The first predetermined voltage may be, for instance, defined by the minimum boost input voltage (Vzₘᵢₙ), as set out in equation (1) above. The actual value of the first predetermined voltage may be defined based on the minimum boost input voltage, e.g., equal to the minimum boost input voltage or a practicable value near to (but greater than) the minimum boost input voltage. The advantage of setting the first predetermined voltage (which may also optionally define the second predetermined voltage) is that this avoids the converter from attempting to operate when the boost input voltage Vx is below a minimum required voltage for performing the necessary boost operation. In doing so, this can maintain zero voltage switching at the switch node 135.

In any event, during the first control phase the transition control system effectively controls the synchronous boost PFC converter 130 to operate in an idle mode, to maintain the voltage Vz at the first input node 111 at Vzₘᵢₙ.

It will be appreciated that the maximum boost input voltage Vzₘₐₓ is given by Vzₘₐₓ=Vb−Vzₘᵢₙ.

In the example illustrated by FIG. 4, the timing pattern for the second control phase comprises three switching cycles (i.e. steps) with seven switching times reducing the peak current (i.e., the number of steps is 3). Of course, in other embodiments, the number of steps or switching cycles may be 2 or may be a number greater than 3. It is possible for the number of steps or switching cycles to be 1, although this is less preferred as this would require components with higher current ratings).

In the illustrated example, which makes use of three steps to transition Vz to the value of Vb, this could reduce a maximum current through the inductor by no less than two thirds. This can allow, for instance, a current through an inductor to fall below the rated value for normal operation.

It will be appreciated that the sizes of the decoupling capacitors will influence the value of the maximum possible current.

FIG. 5 provides a state plane diagram that indicates a negative limit for the maximum inductor current I_{L} during a transition from a positive-negative voltage of the AC input signal. The negative peak of the inductor current I_{L} may not exceed −I_{L-min} and the positive peak must somewhat exceed I_{L-ZVS}, which gives the (voltage-dependent) ZVS limit for the inverter.

Of course, in case of a negative-positive transition (i.e., where the boost input voltage Vz must commutate from Vb to V_{Zmin}), then both the trajectory direction and the inductor current axis I_{L} are inverted.

Under normal operating conditions, the clamping diodes Dz1 and Dz2 are preferably not used at all (i.e., they do not conduct current). For instance, as illustrated in FIG. 4, if controlled appropriately then the voltage Vz at the first input node 111 will not exceed the bus voltage Vb nor become negative (i.e., fall below the ground voltage GND). To put another way, the instantaneous inductor current I_{L} at the end of the transition is close to zero.

However, there are some circumstances in which these requirements will not be met, and the clamping diodes will conduct current. For instance, this can occur if the timing of the switching sequence during the second control phase is not well adapted to the component parameters (L, Cz), in the event of any over-voltages in the AC input signal or due to any EMI filter ringing. Therefore, to account for this non-ideal events and to relax the timing accuracy requirements for control during at least the second control phase, the clamping diodes Dz1 and Dz2 are used for clamping the voltage within safe limits.

The second control phase of control during the transition settles the boost input voltage Vz around the value of the bus voltage Vb without over- or undershooting. This could result in undesired ringing. To overcome this problem, the third control phase is used to effectively operate the synchronized boost PFC converter in an idle mode until the voltage difference Vb−V_{AC} falls below a predetermined threshold voltage (where V_{AC} is the voltage of the AC input signal S_{AC}). At this stage, the transition control system may relinquish its control, and the conventional or normal operation procedure (e.g., QSW mode) may begin again.

The second input node 112 is charged, e.g., via the EMI capacitor, following the first input node 111 before the first rectifying diode D1 is forward biased by the current of the AC input signal after the third control phase when normal PFC operation continues.

FIG. 6 illustrates the current Ib into the output capacitor Co during a transition. This indicates that the energy needed to commence and perform the transition of the voltage at the first input node to the bus voltage Vb comes from the output capacitor. This charge is eventually balanced, indicating a lossless or near-lossless transition.

FIG. 6 also illustrates the current I_{L} through the inductor. The control of the operation of the switches is preferably configured such that this current does not (or is predicted to not) exceed a threshold current. As previously explained, this may require two or more switching cycles, depending upon the parameters of the circuit components.

The approach for controlling the switches during a negative-to-positive zero crossing of the voltage provided by the AC input signal is similar to the above-described approach for positive-to-negative zero crossings.

However, instead of controlling the voltage at the boost input node to reach the high voltage level (e.g., the voltage at the first output node or a biased version thereof), the voltage is controlled to reach a low voltage level (e.g., the minimum boost input voltage, as set out by equation (1)). This is achieved by controlling the discharging of the voltage at the boost input node to the second output node (i.e., to ground GND).

Preferably, the transition control system is configured, during a (e.g., any) negative-to-positive zero crossing of the voltage provided by the AC input, control the voltage Vz at the first input node 111 to reach the low voltage level before the power provided by the AC input signal to the second input node is able to forward bias the second rectifying diode.

The transition control system 134 is preferably configured to, during a (e.g., any) negative-to-positive zero crossing of the voltage provided by the AC input signal to the first input node, control the voltage at the first input node 111 to reach the low voltage level by resonantly discharging the first input node via the inductor of the synchronous boost converter.

This approach effectively “soft-discharges” the voltage at the input node, so that it is gradually reduced over time, rather than being abruptly stepped to the low voltage level. This reduces a noise in the overall power factor correction system.

The transition control system 134 may be configured to, during a negative-to-positive zero crossing of the voltage provided by the AC input signal to the first input node, control the voltage at the first input node to reach the low voltage level, wherein the control is configured such that the magnitude of the current I_{L} through the inductor L of the synchronous boost converter 130 remains below a threshold current I_{TH}.

The approach for controlling the switches during a negative-to-positive zero crossing of the voltage provided by the AC input signal may comprise a similar three-phase sequence of steps to that described for the positive-to-negative zero crossing, but in reverse order—i.e., performing the third control phase, then the second control phase, then the first control phase.

For negative-to-positive zero crossings, in the second control phase, the switching cycle is adapted such that the connection phase comprises connecting the intermediate node 135 to the second output node 122 (and disconnecting the intermediate node from the first output node 121), to thereby discharge/reduce the boost input voltage whilst increasing the magnitude of the current I_{L} through the inductor (but in a reverse direction compared to during the positive-to-negative zero crossings). Similarly, the disconnection phase comprises connecting the intermediate node 135 to the first output node 121 (and disconnecting the intermediate node from the second output node) to dissipate the current through the inductor L.

During negative-to-positive zero crossings, the transition control system may enter the third control phase responsive to the voltage of the AC input signal rising to a second predetermined voltage. The second predetermined voltage may be of the same magnitude as the first predetermined voltage, but of opposite polarity (i.e., negative).

During negative-to-positive zero crossings, the transition control system may move from the third control phase to the second control phase at any point after the voltage of the AC input signal rises above 0V, i.e., performs the zero crossing. This can be performed by monitoring or measuring the voltage of the AC input signal, or may simply be performed after a period of time after initiating the third control phase following which the voltage of the AC input signal is likely to have risen above 0.

During negative-to-positive zero crossings, the transition control system may move from the second control phase to the first control phase responsive to the voltage at the first input node reaching the minimum boost input voltage.

It will be appreciated that the first and/or third phases may be omitted in some embodiments.

The transition control system 134 may be configured to, during a negative-to-positive zero crossing of the voltage provided by the AC input signal, control the voltage at the first input node, by controlling the operation of the first and second switches, to reach a minimum boost input voltage at the first output node in two or more steps, i.e., using two or more switching cycles.

Turning back to FIG. 2, further optional features of the proposed system are hereafter described.

Preferably, the capacitance of the output capacitor is more than 100 times greater than the capacitance of the first decoupling capacitor and/or the second decoupling capacitor. This reduces the stress/strain on the decoupling capacitor(s).

It is possible that the totem pole power factor correction system may comprise a plurality of synchronous boost PFC converters (with a corresponding plurality of output interfaces).

There is also proposed an electronic device arrangement, which comprises any herein proposed totem pole power factor correction system and an electronic device configured to draw power from the totem pole power factor correction system. Preferably, the electronic device is configured to draw less than 10 kW of power.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A totem pole power factor correction system for driving a load, the totem pole power factor correction circuitry comprising:
an input interface comprising:
a first input node and a second input node for receiving an AC input signal from an external power supply; and
an impedance connecting the first input node to the second input node;
an output interface for providing a driving signal to a load, the output interface comprising: a first output node and a second output node for connecting to the load; and an output capacitor connected between the first output node and the second output node;
a synchronous boost PFC converter comprising: an inductor coupled between the first input node and an intermediate node; a first switch connected between the intermediate node and the first output node; and a second switch connected between the intermediate node and the second output node;
a rectifying system comprising: a first rectifying diode connected between the second input node and the first output node; and a second rectifying diode connected between the second output node and the second input node; and
a boost input decoupler comprising:
a first clamping diode connected between the first input node and the first output node;
a second clamping diode connected between the second output node and the first input node; and
one or more decoupling capacitors, wherein each decoupling capacitor is connected between either:
the first input node and the first output node; or
the first input node and the second output node.

2. The totem pole power factor correction system of claim 1, wherein the one or more decoupling capacitors comprise:
a first decoupling capacitor connected between the first input node and the first output node; and
a second decoupling capacitor connected between the first input node and the second output node.

3. The totem pole power factor correction system of claim 1, wherein the input interface comprises an EMI filter for performing EMI filtering on the AC input signal received by the input interface.

4. The totem pole power factor correction system of claim 1, wherein the synchronous boost PFC converter comprises a transition control system for controlling the operation of the first and second switches during a positive-to-negative zero crossing of the voltage provided by the AC input signal to the first input node,
the transition control system being configured to, during a positive-to-negative zero crossing of the voltage provided by the AC input signal control the voltage at the first input node, by controlling the operation of the first and second switches, to reach a high voltage level.

5. The totem pole power factor correction system of claim 4, wherein the transition control system is configured to, during a positive-to-negative zero crossing of the voltage provided by the AC input signal to the first input node, control the voltage at the first input node to reach the high voltage level before the power provided by the AC input signal to the second input node is able to forward bias the first rectifying diode.

6. The totem pole power factor correction system of claim 4, wherein the transition control system is configured to, during a positive-to-negative zero crossing of the voltage provided by the AC input signal, control the voltage at the first input node to reach the high voltage level by resonantly charging the first input node via the inductor of the synchronous boost converter.

7. The totem pole power factor correction system of claim 4, wherein the transition control system is configured to, during a positive-to-negative zero crossing of the voltage provided by the AC input signal, control the voltage at the first input node to reach the high voltage level, wherein the control is configured such that the magnitude of the current through the inductor of the synchronous boost converter remains below a threshold current.

8. The totem pole power factor correction system of claim 4, wherein the transition control system is configured to, during the positive-to-negative zero crossing of the voltage provided by the AC input signal, control the voltage at the first input node, by controlling the operation of the first and second switches, to reach the high voltage level in two or more voltage steps.

9. The totem pole power factor correction system of claim 4, wherein the transition control system is configured to, during a positive-to-negative zero crossing of the voltage provided by the AC input signal to the first input node:
enter a first control phase during which the transition control system controls the operation of the first and second switch such that the voltage at the first input node is maintained;
after the first control phase, enter a second control phase during which the transition control system controls the operation of the first and second switch such that the voltage at the first input node reaches the high voltage level; and
after the voltage at the first input node reaches the high voltage level, enter a third control phase during which the transition control system controls the operation of the first and second switch such that the voltage at the first input node is maintained at the high voltage level.

10. The totem pole power factor correction system of claim 4, wherein the transition control system is further configured to control the operation of the first and second switches during a negative-to-positive zero crossing of the voltage provided by AC input signal to the first input node,
the transition control system being configured to, during a negative-to-positive zero crossing of the voltage provided by AC input signal to the first input node, control the voltage at the first input node, by controlling the operation of the first and second switches, to reach a low voltage level.

11. The totem pole power factor correction system of claim 10, wherein the transistor control system is configured to, during a negative-to-positive zero crossing of the voltage provided by AC input signal to the first input node:
enter a fourth control phase during which the transition control system controls the operation of the first and second switch such that the voltage at the first input node is maintained;
after the fourth control phase, enter a fifth control phase during which the transition control system controls the operation of the first and second switch such that the voltage at the first input node reaches the low voltage level; and
after the voltage at the first input node reaches the low voltage level, enter a sixth control phase during which the transition control system controls the operation of the first and second switch such that the voltage at the first input node is maintained at the low voltage level.

12. The totem pole power factor correction system of claim 10, wherein the transition control system is configured to, during the negative-to-positive zero crossing of the voltage provided by the AC input signal, control the voltage at the first input node, by controlling the operation of the first and second switches, to reach the low voltage level in two or more steps.

13. The totem pole power factor correction system of claim 4, wherein the transition control system is configured to control the operation of the first and second switches responsive to the magnitude of the voltage provided by the AC input signal falling below a first predetermined threshold.

14. The totem pole power factor correction system of claim 13, wherein the transition control system is configured to relinquish control of the operation of the first and second switches responsive to the magnitude of the voltage provided by the AC input signal rising above the first predetermined threshold.

15. An electronic device arrangement comprising:
an electronic device configured to draw less than 10 kW; and
the totem pole power factor correction system of claim 1.
